(19) United States
(12) Patent Application Publication
(10) Pub. No.: US 2014/0136827 A1
(43) Pub. Date: May 15, 2014

(54) MOBILE DEVICE AND DATA COMMUNICATION METHOD OF SEMICONDUCTOR INTEGRATED CIRCUIT OF MOBILE DEVICE

(71) Applicants: EUNSEOK CHO, Suwon-si (KR); JAE CHOON KIM, Incheon (KR); YUNHYEOK IM, Hwaseong-si (KR)

(72) Inventors: EUNSEOK CHO, Suwon-si (KR); JAE CHOON KIM, Incheon (KR); YUNHYEOK IM, Hwaseong-si (KR)

(21) Appl. No.: 14/059,428

(22) Filed: Oct. 21, 2013

(30) Foreign Application Priority Data
Nov. 15, 2012 (KR) 10-2012-0129544

(51) Int. Cl. G06F 9/50; G01K 7/01

(52) U.S. Cl. CPC G06F 9/5094; G01K 7/01
USPC 713/1; 374/178

(57) ABSTRACT

According to one general aspect, a data communication method may include detecting a temperature using a temperature sensor. The method may include selecting a bandwidth for data communications by a semiconductor integrated circuit based, at least in part, upon the detected temperature. The method may also include performing the communication of data based, at least in part, on the selected bandwidth.

### CROSS-REFERENCE TO RELATED APPLICATIONS

A claim for priority under 35 U.S.C. §119 is made to Korean Patent Application No. 10-2012-0129544 filed Nov. 15, 2012, in the Korean Intellectual Property Office, the entire contents of which are hereby incorporated by reference.

### BACKGROUND

The concepts described herein relate to a semiconductor device, and more particularly, relate to a mobile device and a data communication technique that may be employed a semiconductor integrated circuit of a mobile device.

In recent years, the use of portable intelligence such as a smart phone, a tablet, a notebook computer, and so on may increase rapidly and become more ubiquitous. The development of semiconductor and communications technologies may cause an increase in computing power or processing throughput of such forms of portable intelligence. In various embodiments, such forms of advanced portable intelligence or computing devices may be generally referred to a “smart device”.

Often, the smart device may enable a user to install applications freely and to produce and process information using the installed applications. The smart device may include a processor which is configured to operate at a high or suitably sufficient processing speed and also consumes sufficiently little power to be suitable as a mobile device. Such a processor may be called an “application processor”.

Occasionally, such high performance by the processor of the smart device may be accompanied by a heat issue. Frequently, the performance (e.g., speed, voltage, frequency, etc.) of components (e.g., the processor, etc.) in the smart device may be lowered in order to reduce the heat generated at the smart device. Occasionally, the heat generated at the smart device may cause in abnormal operation and also damage of one or more of the components in the smart device. Thus, ways to solve or reduce such heat issues associated with the smart device may be desirable.

### SUMMARY

One embodiment of the disclosed subject matter is directed to provide a data communication method comprising detecting a peripheral temperature using a temperature sensor; selecting a bandwidth for data communications the communication of data by a semiconductor integrated circuit based, at least in part, upon the detected temperature; and performing the communication of data based, at least in part, on the selected bandwidth.

In example embodiments, the data communications may be performed with a peripheral circuit connected with the semiconductor integrated circuit through an electric path.

In example embodiments, the temperature sensor may be embedded in the semiconductor integrated circuit or installed outside of the semiconductor integrated circuit.

In example embodiments, the selecting a bandwidth may comprise selecting a first number of channels when the detected temperature is lower than a reference; and selecting a reduced or second number of channels less than the normal channels when the detected temperature is higher than the reference.

In example embodiments, the channels for the communication of data may provide independent and parallel channels of communication between a peripheral circuit and the semiconductor integrated circuit.

In example embodiments, the semiconductor integrated circuit may be connected with a peripheral circuit via a plurality of channels for the communication of data. In such an embodiment, selecting a bandwidth may comprise activating, substantially simultaneously, either the first number channels or the second number channels of the plurality of channels that are connected between the semiconductor integrated circuit and the peripheral circuit.

In example embodiments, the selecting a bandwidth may comprise selecting a normal or first data transmission rate when the detected temperature is lower than a reference or threshold temperature; and selecting a reduced or second data transmission rate lower than the normal data transmission rate when the detected temperature is higher than the reference or threshold temperature.

In example embodiments, the semiconductor integrated circuit may include an application processor and the data communications may be performed between the application processor and a memory communicating with the application processor.

In example embodiments, the semiconductor integrated circuit may include a memory and the data communications may be performed between the memory and an application processor communicating with the memory.

Another embodiment of the disclosed subject matter is directed to a mobile device which may comprise an application processor; and a memory configured to communicate with the application processor, wherein the application processor and the memory are configured to communicate with each other based on a bandwidth varied according to a peripheral temperature.

In example embodiments, the application processor may comprise a temperature sensor configured to detect the peripheral temperature and the application processor may be configured to change a number of channels for communication with the memory according to the peripheral temperature detected by the temperature sensor.

In example embodiments, the application processor may comprise a temperature sensor configured to detect the peripheral temperature and the application processor may be configured to change a data transmission rate for communication with the memory according to the peripheral temperature detected by the temperature sensor.

In example embodiments, the application processor may comprise a temperature sensor configured to detect the peripheral temperature and the memory may be configured to change a number of channels employed for communication with the application processor according to the peripheral temperature detected by the temperature sensor.

In example embodiments, the application processor may be further configured to adjust a frequency of an internal clock according to the peripheral temperature.

In example embodiments, the application processor and the memory may be formed in the form of a package-on-package.

With embodiments of the disclosed subject matter, a bandwidth for data communications of a semiconductor integrated circuit may be adjusted according to a peripheral temperature. Thus, it is possible to provide an improved heat management function.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a mobile device according to an embodiment of the disclosed subject matter;

FIG. 2 is a flow chart illustrating a data communication method of a semiconductor integrated circuit according to an embodiment of the disclosed subject matter;

FIG. 3 is a flow chart illustrating a data communication bandwidth selecting method according to an embodiment of the disclosed subject matter;

FIG. 4 is a block diagram schematically illustrating a memory according to an embodiment of the disclosed subject matter;

FIG. 5 is a flow chart illustrating a data communication bandwidth selecting method according to another embodiment of the disclosed subject matter;

FIG. 6 is a diagram illustrating an example embodiment of an application processor and a memory;

FIG. 7 is a block diagram schematically illustrating a mobile device according to another embodiment of the disclosed subject matter;

FIG. 8 is a flow chart illustrating a data communication method of a semiconductor integrated circuit according to another embodiment of the disclosed subject matter;

FIG. 9 is a flow chart illustrating a clock frequency selecting method according to an embodiment of the disclosed subject matter;

FIG. 10 is a block diagram schematically illustrating an application of an application processor according to an embodiment of the disclosed subject matter;

FIG. 11 is a block diagram schematically illustrating a mobile device according to still another embodiment of the disclosed subject matter; and

FIG. 12 is a block diagram schematically illustrating an example embodiment of a memory of FIG. 11.

FIG. 13 is a flow chart illustrating a data communication mode selection technique according to another embodiment of the disclosed subject matter.

### DETAILED DESCRIPTION

Embodiments will be described in detail with reference to the accompanying drawings. The disclosed subject matter, however, may be embodied in various different forms, and should not be construed as being limited only to the illustrated embodiments. Rather, these embodiments are provided as examples so that this disclosure will be thorough and complete, and will fully convey the concept of the disclosed subject matter to those skilled in the art. Accordingly, known processes, elements, and techniques are not described with respect to some of the embodiments of the disclosed subject matter. Unless otherwise noted, like reference numerals denote like elements throughout the attached drawings and written description, and thus descriptions will not be repeated. In the drawings, the sizes and relative sizes of layers and regions may be exaggerated or reduced for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the disclosed subject matter.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it may be the only layer between the two layers, or one or more intervening layers may also be present.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

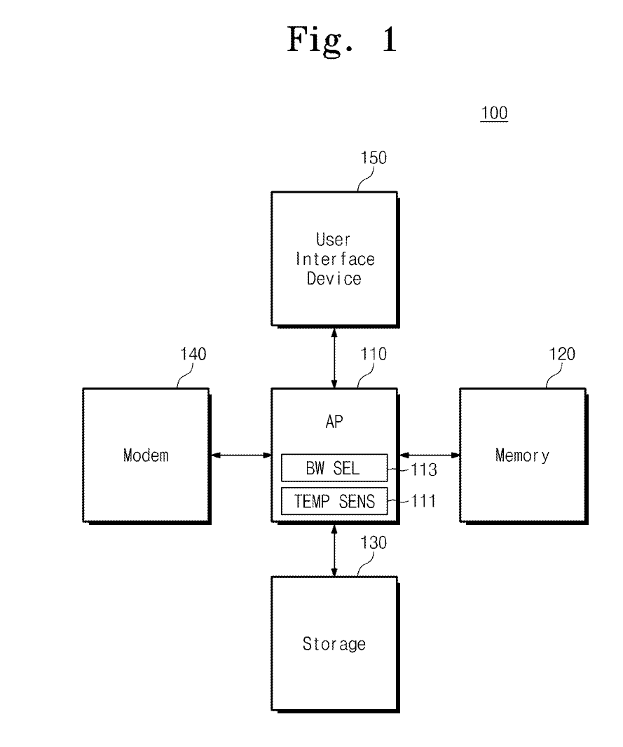

FIG. 1 a block diagram illustrating a mobile device 100 according to an embodiment of the disclosed subject matter. Referring to FIG. 1, a mobile device 100 may comprise an application processor (AP) 110, a memory 120, storage 130, a modem 140, and a user interface device 150.

The application processor 110 may control an overall operation of the mobile device 100, and may perform various logical functions. In one embodiment, the application processor 110 may include a System-on-Chip (SoC), a microprocessor, portions of a chipset, or anther integrated circuit. It is understood that the above are merely a few illustrative examples to which the disclosed subject matter is not limited. The application processor 110 may comprise a temperature sensing unit 111 and/or a bandwidth selecting unit 113.

The temperature sensing unit 111 may be configured to detect a peripheral or substantially surface temperature of the application processor 110. The temperature sensing unit 111 may be located outside or inside the application processor 110 to detect the peripheral temperature or a temperature substantially similar to the surface or outer temperature of the application processor 110. The temperature sensing unit 111 may include a hardware component, such as a thermal couple, a thermistor, a resistance temperature detector, etc. It is understood that the above are merely a few illustrative examples to which the disclosed subject matter is not limited.

The bandwidth selecting unit 113 may be configured to select a data communication bandwidth for the application processor 110. In such an embodiment, the bandwidth selecting unit 113 may reduce or increase the bandwidth used for communication between the application processor 110 and another component of the mobile device 100 (e.g., the memory 120, the modem 140, the storage 130, etc.). In various embodiments, bandwidth selecting unit 113 may select the bandwidth or data rate according to a peripheral temperature as detected by the temperature sensing unit 111.

The bandwidth selecting unit 113 may, for example, be configured to select a bandwidth for communication between the application processor 110 and the memory 120, a bandwidth for communication between the application processor 110 and the storage 130, a bandwidth for communication between the application processor 110 and the modem 140, or a bandwidth for communication between the application processor 110 and the user interface device 150. The bandwidth selecting unit 113 may also select a bandwidth for communication between the application processor 110 and other components (not shown) of the mobile device 100.

In various embodiments, the bandwidth selecting unit 113 may, for example, be configured to select individual data rates or bandwidths for each component such that their exist a plurality of communication channels (e.g., one between the AP 110 and the memory 120, a second between the AP 110 and the storage 130, etc.), each operating a respective bandwidths or data rates. In some embodiments, one or more of these individual communication channels may have the same or substantially the same bandwidths. In another embodiment, two or more of these components may be grouped together for purposes of bandwidth selection. In yet another embodiment, all communication (managed by the bandwidth selector 113) between the application processor 110 and the various components may operate using or employ a single bandwidth or data rate. It is understood that the above are merely a few illustrative examples to which the disclosed subject matter is not limited.

The bandwidth selecting unit 113 may be or include a software component executed by the application processor 110. Alternatively, the bandwidth selecting unit 113 may be or include a hardware component of the application processor 110. The bandwidth selecting unit 113 may be implemented by combination of a hardware component of the application processor 110 and a software component executed by the application processor 110.

The memory 120 may communicate with the application processor 110. The memory 120 may be a working memory (or, a main memory) of the application processor 110 or the mobile device 100.

The memory 120 may comprise volatile memories such as a static random access memory (RAM), a dynamic RAM (DRAM), a synchronous DRAM, etc. In various embodiments, the memory 120 may comprise non-volatile memories such as a phase-change RAM, a magnetic RAM, a resistive RAM, a ferroelectric RAM, etc. In another embodiment, the memory 120 may include a combination of volatile and non-volatile memories, as described above.

The storage 130 may store data used or employed by the mobile device 100. In various embodiments, this stored data may be retained long term, compared to data stored by the memory 130. The storage 130 may include a hard disk drive or a nonvolatile memory such as a flash memory, a phase-change RAM, a magnetic RAM, a resistive RAM, a ferroelectric RAM, or the like. It is understood that the above are merely a few illustrative examples to which the disclosed subject matter is not limited.

In example embodiments, the memory 120 and storage 130 may be formed of the same type of nonvolatile memories. In some embodiments, the memory 120 and storage 130 may be integrated together. for example, as part pf a single semiconductor chip. It is understood that the above is merely one illustrative example to which the disclosed subject matter is not limited.

The modem 140 may be configured to communicate with an external device (not shown). In some embodiments, this may occur according to or be controlled by the application processor 110. For example, the modem 140 may perform wire or wireless communications with an external device. The modem 140 may communicate using at least one of wire and/or wireless communications techniques or protocols. In some embodiments, the wireless communications techniques or protocols may include, but are not limited to, LTE (Long Term Evolution), WiMax, GSM (Global System for Mobile communication), CDMA (Code Division Multiple Access), Bluetooth, NFC (Near Field Communication), WiFi, RFID (Radio Frequency Identification), etc. In various embodiments, the wire communications techniques or protocols may include USB (Universal Serial Bus), SATA (Serial AT Attachment), SCSI (Small Computer Small Interface), Firewire, PCI (Peripheral Component Interconnection), etc. It is understood that the above are merely a few illustrative examples to which the disclosed subject matter is not limited.

The user interface (UI) or user interface device 150 may facilitate communication with a user (not shown). In various embodiments, this may occur, at least partially, according to or under the control of the application processor 110. For example, the user interface device 150 may include user input interfaces or devices such as a keyboard, a keypad, a button, a touch panel, a touch screen, a touch ball, a touch pad, a camera, a gyroscope sensor, a vibration sensor, etc. The user interface device 150 may include user output interfaces or devices such as an LCD (Liquid Crystal Display), an OLED (Organic Light Emitting Diode) display device, an AMOLED (Active Matrix OLED) display device, an LED, a speaker, a motor, and etc. It is understood that the above are merely a few illustrative examples to which the disclosed subject matter is not limited.

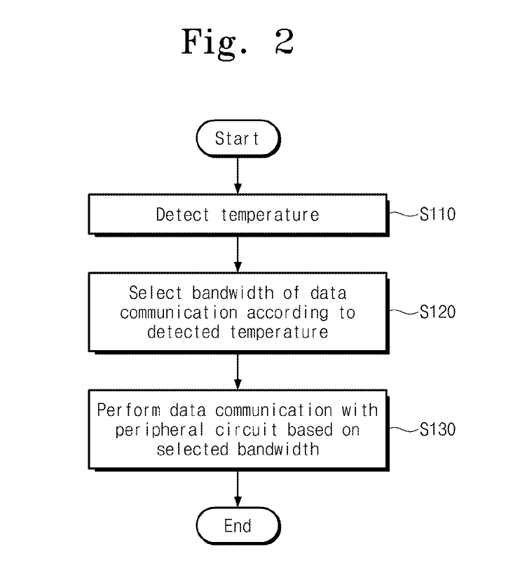

FIG. 2 is a flow chart illustrating a data communication method of a semiconductor integrated circuit according to an embodiment of the disclosed subject matter. In one embodiment, the technique illustrated In FIG. 2 may be performed by a processor, such as, for example an application processor 110 of FIG. 1.

Referring to FIGS. 1 and 2, in operation S110, a temperature may be detected. For example, a temperature sensing unit 111 may detect an internal or external peripheral temperature of an application processor 110.

In operation S 120, a bandwidth for data communications may be selected according to or based, at least in part, upon the detected temperature. For example, a bandwidth selecting unit 113 may select a bandwidth for communications between the application processor 110 and a peripheral or external circuit or component according, at least in part, to the detected temperature. The bandwidth selecting unit 113 may select a bandwidth for communications between the application processor 110 and a component such as a memory 120, storage 130, a modem 140, a user interface device 150, etc.

In operation S 130, data communication with a peripheral circuit, device, or component may be performed using the selected bandwidth. An application processor 110 may communicate with a peripheral circuit, device, or component based on the selected bandwidth. In one embodiment, the communication may occur within the confines of the selected bandwidth or data rate. In such an embodiment, the application processor 110 and peripheral device may exchange information at a rate up to or less than a maximum data rate proscribed by the selected bandwidth. In various embodiments, the application processor 110 may communicate with the memory 120, the storage 130, the modem 140, or the user interface 150 based on the selected bandwidth, as described above.

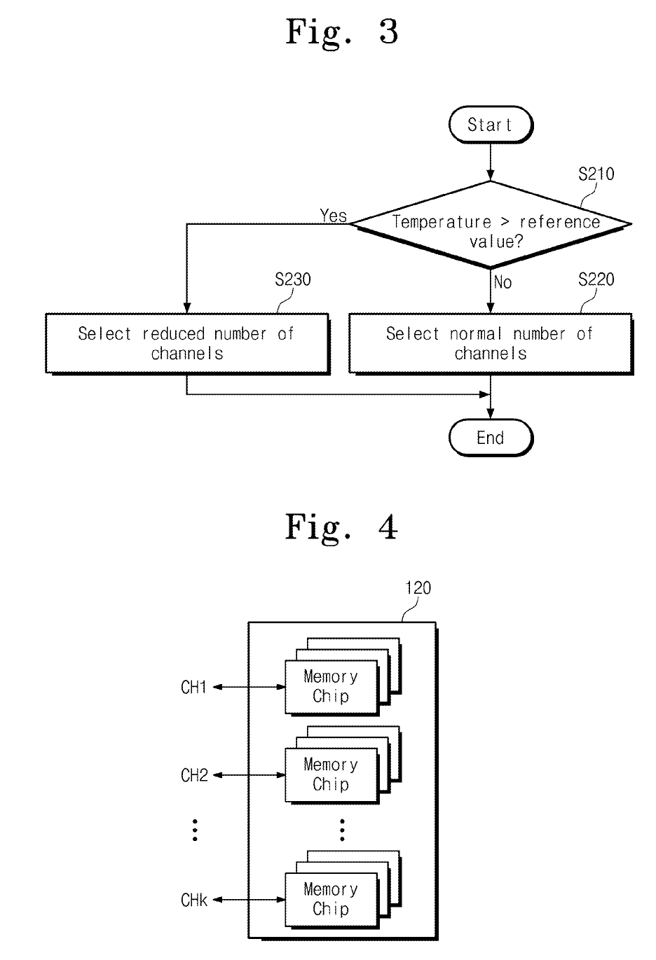

FIG. 3 is a flow chart illustrating a data communication bandwidth selecting method according to an embodiment of the disclosed subject matter. Referring to FIGS. 1 and 3, in operation S210, it may be determined whether or not a detected temperature is higher than a reference or predefined threshold temperature. If the detected temperature is lower than the reference or threshold temperature, the method may proceed to operation S220, in which a “normal” or predefined number of communication channels is selected or assigned to communication between the application processor and the respective peripheral device. If the detected temperature is higher than the reference or threshold temperature, the method may proceed to operation S230, in which a reduced number of channels is selected or assigned to communication between the application processor and the respective peripheral device. In such an embodiment, the reduced number of channels of operation S230 may be less than the normal or predefined number of communication channels of operation S220.

In various embodiments, the “normal” number of channels may be a predefined number of channels through which an application processor 110 generally communicates with peripheral circuits, devices, or components. Conversely, the reduced number of channels may mean the number of channels less than the “normal” number of channels. In one embodiment, the application processor 110 may communicate using the reduced number of channels number may reduce heat; although, it is understood that the above is merely one illustrative example to which the disclosed subject matter is not limited.

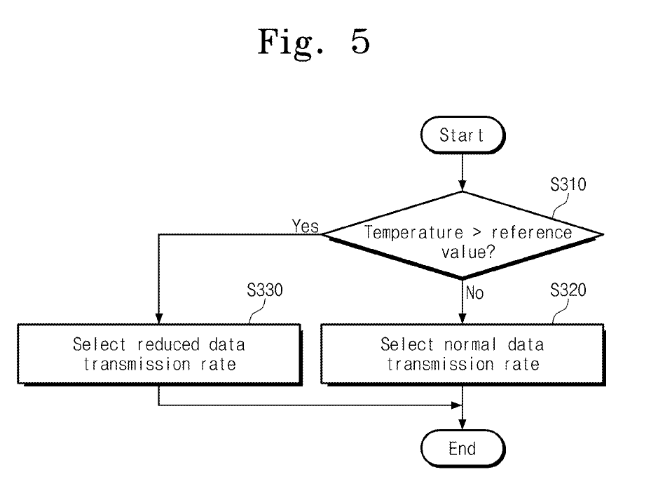

FIG. 4 is a block diagram schematically illustrating a memory 120 according to an embodiment of the disclosed subject matter. Referring to FIGS. 1 and 4, a memory 120 may include a plurality of memory chips which are divided into a plurality of memory groups. Each memory group may include one or more memory chips. The memory groups may, in one embodiment, be connected or communicably coupled with an application processor 110 through a plurality of channels CH1, CH2, CHk, etc.

In various embodiments, when a temperature (e.g., detected by a temperature sensing unit) is lower than a reference or threshold temperature, the application processor 110 may communicate with a peripheral circuit, device or component (e.g., the memory 120) through a plurality of channels (e.g., CH1 to CHk, etc.). In various embodiments, the number of “normal” channels used may be predefined. In one such embodiment, the number of channels used during a normal operation mode may include all of the available channels (e.g., CH1 to CHk, etc.). In some embodiments, the plurality of channels CH1 to CHk may provide independent and parallel communication paths between the application processor and the respective peripheral device (e.g., memory 120). In one embodiment, the plurality of channels CH1 to CHk can be activated at the same time. In another embodiment, the plurality of channels may be activated individually.

However, in various embodiments, when a temperature detected by a temperature sensing unit is higher than the reference or threshold temperature, the application processor 110 may communicate with a peripheral circuit, device, or component (e.g., the memory 120) through a part or subset of the plurality of channels CH1 to CHk. In such an embodiment, the processor may communicate using only a reduced number of channels (e.g., CH1 and CH2, etc.). For example, the number of channels, activated or available for substantially simultaneous use may be limited. In such an embodiment, the amount of bandwidth or the overall data rate between the processor and the peripheral device may be reduced.

In one embodiment, if the number of channels for communications between the application processor 110 and the memory 120 is reduced (e.g., from CH1-CHk down to only CH1 and CH2. etc.), an access frequency of the memory 120 may be reduced. In such an embodiment, as heat is generated due, in part, to memory accesses, the heat generated due the application processor 110 and the memory 120 may be reduced. It is understood that the above is merely one illustrative example to which the disclosed subject matter is not limited.

In various embodiments, when the temperature of the application processor 110 (or the peripheral temperature) is lower than the reference or threshold, the number of channels available or usable for communication may be increased (e.g., from only CH1 and CH2 up to CH1-CHk etc.). In such an embodiment, the application processor 110 may then communicate with a peripheral circuit, device, or component (e.g., memory 120, etc.) using the normal or all number of channels. Thus, a mobile device may operate in an optimized or dynamic speed.

In such an embodiment, when the measured temperature of the application processor 110 is less than the reference of threshold temperature, the application processor 110 may communicate with a peripheral circuit using the “normal”, greater, or all number of channels. Thus, the mobile device may operate more efficiently and more quickly. Conversely, when the measured temperature of the application processor 110 is higher than the reference of threshold temperature, the application processor 110 may communicate with a peripheral circuit using the reduced number of channels. Thus, heat generated from the mobile device 100 may be reduced, so that abnormal operation of and any damage to the mobile device 100 may be prevented. In various embodiments, if the measured temperature is equal to the threshold temperature, the application processor may use of either the “normal” or reduced number of channels based upon the embodiment.

In example embodiments, as illustrated in the following table 1, a bandwidth selecting unit 113 may select the number of channels using two or more references or threshold temperatures.

TABLE 1

| Temperature | Channel Mode |
|---|---|
| Lower than 1^{st} reference or threshold temperature | Full Channel |
| Higher than 1^{st} reference or threshold temperatures and | Half Channel |
| lower than 2^{nd} reference or threshold temperatures | |
| Higher than 2^{nd} reference or threshold temperatures | Quarter Channel |

In the embodiment shown in Table 1, full channel mode may correspond to allowing the application processor to make use of the “normal” channels or all of the possible channels. The half channel mode may correspond to allowing the application processor to make use of half the number of “normal” or existing channels. The quarter channel mode may correspond to allowing the application processor to make use of a quarter or a fourth of the number of “normal” or existing channels.

In such an embodiment, if a memory (e.g., memory 120 of FIG. 4) included or had four channels (CH1, CH2, CH3, and CH4, etc.) for communication with the application processor, the full channel mode may allow communication via all four channels. The half channel mode may allow communication via only two channels (e.g., CH1 & CH2, CH3 & CH4, CH1 & CH3, CH1 & CH4, etc.). The quarter channel mode may allow communication via only one of the channel (e.g., CH1, CH2, CH3, or CH4, etc.).

In some embodiments, a level of a bandwidth for data communications with the application processor 110 may not be limited in the way described above. In another embodiment, a bandwidth for data communications with the application processor 110 may be adjusted according to a temperature and may involve two levels (refer to FIG. 3). In yet another embodiment, the adjustment may involve three levels (refer to table 1). Further, a bandwidth for data communications with the application processor 110 may be adjusted according to a temperature and may involve four or more levels or more generally a plurality of levels.

In FIGS. 3 and 4, there is described an example in which the application processor 110 adjusts the number of channels for communications with a memory 120. However, it is understood that the above are merely a few illustrative examples to which the disclosed subject matter is not limited.

FIG. 5 is a flow chart illustrating a data communication bandwidth selecting technique according to another embodiment of the disclosed subject matter. Referring to FIGS. 1 and 5, in operation S310, it may be determined whether or not a detected temperature (e.g. the peripheral or surface temperature of a processor, etc.) is higher than a reference or threshold temperature. If the detected temperature is lower than the reference of threshold temperature, the method may proceed to operation S320, in which a “normal” data transmission rate or first data transmission mode is selected. If the detected temperature is higher than the reference or threshold temperature, the method may proceed to operation S330, in which a reduced data transmission rate or second data transmission mode is selected.

In example embodiments, an application processor 110 may vary a data transmission rate or mode for communications with a memory or other peripheral device or component according to the detected temperature. In such an embodiment, the data transmission rate between the application processor 110 and the peripheral device is reduced, peripheral device may be accessed less frequently. In such an embodiment, the amount of heat generated due to communication between the application processor 110 and peripheral device may be reduced.

In such an embodiment, when the measured temperature of the application processor 110 is less than the reference of threshold temperature, the application processor 110 may communicate with a peripheral circuit using the “normal”, greater, or all number of channels. Thus, the mobile device may operate more efficiently and more quickly. Conversely, when the measured temperature of the application processor 110 is higher than the reference of threshold temperature, the application processor 110 may communicate with a peripheral circuit using the reduced number of channels. Thus, heat generated from the mobile device 100 may be reduced, so that abnormal operation of and any damage to the mobile device 100 may be prevented. In various embodiments, if the measured temperature is equal to the threshold temperature, the application processor may use of either the “normal” or reduced number of channels based upon the embodiment.

In example embodiments, such as that illustrated in table 1, a bandwidth selecting unit 113 may select a data transmission rate based on a plurality of operating modes. It is understood that the above is merely one illustrative example to which the disclosed subject matter is not limited.

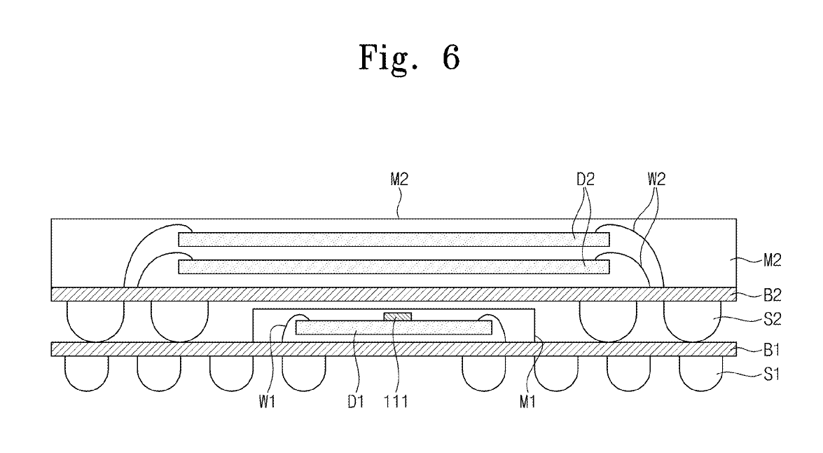

FIG. 6 is a diagram illustrating an example of embodiment that may include an application processor 110 and a memory 120. Referring to FIGS. 1 and 6, an application processor 110 and a memory 120 may be made in the form of a PoP (Package-on-Package). In various embodiments, other forms of integrated circuits may be created that include an application processor 110 and a peripheral device (e.g., a memory 120, etc.).

The application processor 110 may include a substrate B1, solder balls 51, a semiconductor die D1, a temperature sensing unit 111, bonding wires W1, and a molding M1. Components of the application processor 110 may be formed as part of the semiconductor die D1. The semiconductor die D1 may be connected with the substrate B1 through the bonding wires W1. The semiconductor die D1 and the bonding wires W1 may be surrounded, at least partially, by the molding M1. The substrate B1 may include a printed circuit board (PCB). The substrate B1 may be connected with the solder balls Si for electrical connection with other components.

The memory 120 may include a substrate B2, solder balls S2, semiconductor dies D2, bonding wires W2, and a molding M2. Components of the memory 120 may be formed on the semiconductor dies D2. The semiconductor dies D2 may include a CoC (Chip-on-Chip). The semiconductor dies D2 may be connected with the substrate B2 through the bonding wires W2. The semiconductor dies D2 and the substrate B2 may be surrounded, at least partially, by the molding M2. The substrate B2 may include a printed circuit board (PCB). The substrate B2 may be connected with the solder balls S2 for connection, at least electrically, with other components. The solder balls S2 may be connected with the substrate B1 of the application processor 110.

In the event that the application processor 110 and the memory 120 are made in the form of a package-on-package, the peripheral or measured temperature of the application processor 110 may be similar to that of the memory 120. Thus, as described with reference to FIGS. 1 to 5, if a bandwidth is adjusted according to a temperature detected by the temperature sensing unit 111 of the application processor 110, it may be possible to prevent the application processor 110 and the memory 120 from being damaged or operating abnormally due to heat.

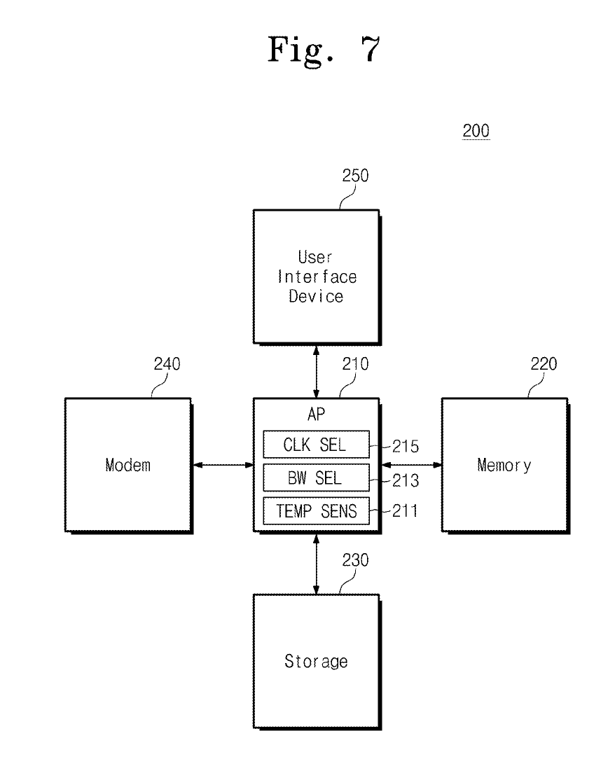

FIG. 7 is a block diagram illustrating a mobile device 200 according to another embodiment of the disclosed subject matter. Referring to FIG. 7, a mobile device 200 may include an application processor 210, a memory 220, storage 230, a modem 240, and a user interface device 250. Compared with a mobile device 100 in FIG. 1, the mobile device 200 may further comprise a clock selecting unit 215, as described below.

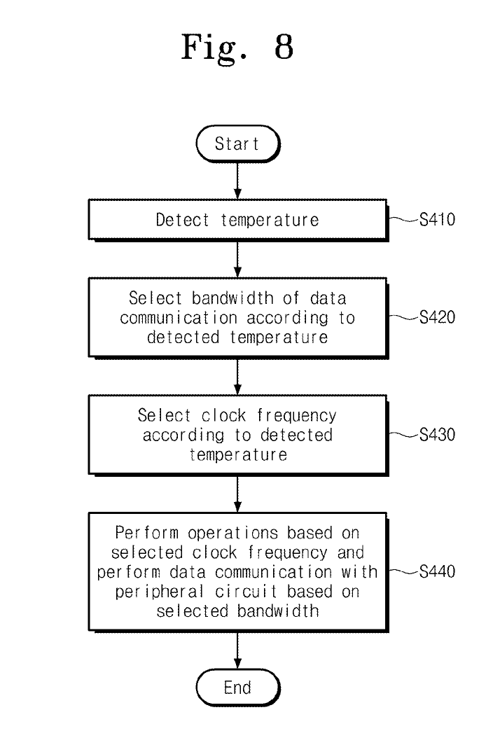

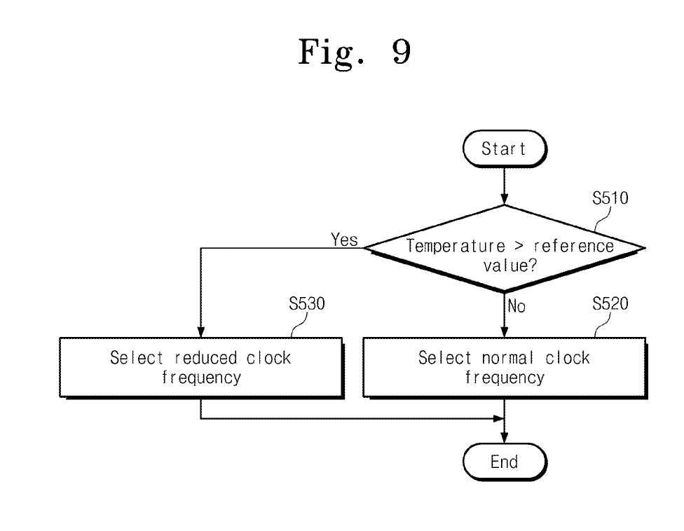

FIG. 8 is a flow chart illustrating a data communication method of a semiconductor integrated circuit according to another embodiment of the disclosed subject matter. In FIG. 8, there is illustrated a data communication method of an application processor 210 of FIG. 7.

Referring to FIGS. 7 and 8, in operation S410, a temperature may be detected.

For example, a temperature sensing unit 211 may detect an internal or external peripheral temperature of an application processor 210.

In operation S420, a bandwidth, data rate, or number of channels for data communications may be selected according to the detected temperature. For example, a bandwidth selecting unit 213 may select a bandwidth, data rate, or number of channels of the application processor 210 for communications with a peripheral circuit. The bandwidth selecting unit 213 may select a bandwidth, data rate, or number of channels of the application processor 210 for communications with the memory 220, the storage 230, the modem 240, the user interface device 250, etc.

In operation S430, a clock frequency may be selected according to the detected temperature. For example, a clock selecting unit 215 may select a frequency of an internal clock of the application processor 210 according to a peripheral temperature detected by the temperature sensing unit 211. In another embodiment, the clock selecting unit 215 may be configured to select a clock frequency for the data communication between the application processor 210 ad the peripheral circuit.

In operation S440, operations may be performed base on the selected clock frequency, and data communications with a peripheral device or component may be performed based on the selected bandwidth, data rate or number of channels. In example embodiments, the application processor 210 may perform various operations (e.g., computation, control, communications, etc.) based on a clock frequency selected by the clock selecting unit 215. In particular, the application processor 210 may communicate with a peripheral circuit based on a bandwidth selected by the bandwidth selecting unit 213. The application processor 210 may communicate with the memory 220, the storage 230, the modem 240, or the user interface device 250, based on the bandwidth selected by the bandwidth selecting unit 213.

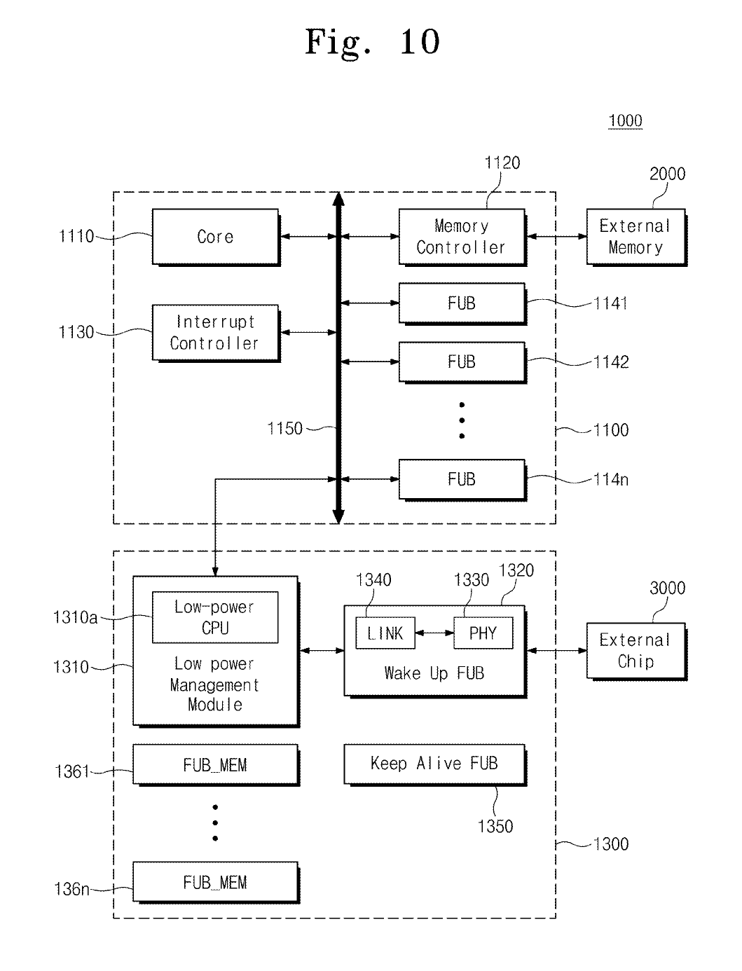

FIG. 9 is a flow chart illustrating a clock frequency selecting method according to an embodiment of the disclosed subject matter. Referring to FIGS. 7 and 9, in operation S510, it may be determined whether or not a detected temperature is higher than a reference or threshold temperature. In operation S520, if the detected temperature is lower than the reference or threshold temperature, a normal clock frequency may be selected. If the detected temperature is higher than the reference or threshold temperature, in operation S530, a reduced clock frequency that is lower than the normal clock frequency may be selected.

The normal clock frequency may include a clock frequency at which an application processor 210 normally operates or a predefined clock frequency. The reduced clock frequency may be a frequency which is lower than the normal or predefined clock frequency and may reduce heat of the application processor 210.

If a clock frequency of the application processor 210 decreases, an operating period of the application processor 210 may increase. In this case, heat generated by the application processor 210 may be reduced. Thus, it is possible to reduce the likelihood that the application processor 210 may be damaged or operate abnormally due to the heat. It is understood that the above is merely one illustrative example to which the disclosed subject matter is not limited.

In example embodiments, a first reference or threshold temperature for selecting a bandwidth may be different from a second reference or threshold temperature for selecting a clock frequency. The first reference or threshold temperature may be lower than the second reference or threshold temperature. In one embodiment, as a temperature detected by a temperature sensing unit 211 increases, first, a decrease in a bandwidth, data rate, or number of channels for data communication may be made. If the temperature detected by the temperature sensing unit 211 further increases, a decrease in a clock frequency may be further made. In another embodiment, the clock frequency may be reduced before the bandwidth, data rate, or number of channels for data communication may be reduced. In yet another embodiment, the clock frequency and bandwidth, data rate, or number of channels for data communication may be reduced substantially simultaneously. It is understood that the above are merely a few illustrative examples to which the disclosed subject matter is not limited.

An operating performance of a mobile device 200 may be largely based on a clock frequency rather than a bandwidth, data rate, or number of channels associated with an application processor 210 for data communications. In various embodiments, minimal lowering of the operating performance of the mobile device 200 and a level of heat reduction may be accomplished, when a temperature increases, by first performing a decrease of a bandwidth rather than a reduction in clock frequency. In various embodiments, a reduction in likelihood of abnormal operation and/or damage to the mobile device 200 may result by additionally lowering the clock frequency when the temperature further increases.

FIG. 10 is a block diagram schematically illustrating an application of an application processor according to an embodiment of the disclosed subject matter. Referring to FIG. 10, an application processor 1000 may comprise a power-off domain block or portion 1100 and a power-on domain block or portion 1300.

The power-off domain block or portion 1100 may include a block or portion which may be powered down to realize a reduction or lowing of the power consumption of the application processor 1000. The power-on domain block or portion 1300 may include a block or portion which is powered on, when the power-off domain block 1100 is powered down, in order to perform at least a portion of the functions of the currently unavailable power-off domain block 1100. In some embodiments, power-on domain block or portion 1300 may be powered on even when the power-off domain block 1100 is not powered down.

The power-off domain block 1100 may include a core 1110, an interrupt controller 1130, a memory controller 1120, a plurality of combinatorial logic blocks (CLBs) or functional unit blocks (FUBs) 1141 to 114n, and a system bus 1150.

The core 1110 may, in one embodiment, control the memory controller 1120 to access an external memory 2000. The memory controller 1120 may send and receive data stored by the external memory 2000 via the system bus 1150 in response to a control of the core 1110.

When an interrupt (i.e., a specific event) is generated from each of the FUBs 1141 to 114n, the interrupt controller 1130 may inform the core 1110 of the interrupt. The FUBs 1141 to 114n may perform concrete operations according to a function of the application processor 1000. The FUBs 1141 to 114n may access internal memories 1361 to 136n, respectively. The power-on domain block 1300 may include the internal memories 1361 to 136n of the FUBs 1141 to 114n.

The power-on domain block 1300 may include a lower-power management module 1310, a wakeup FUB 1320, a keep alive FUB 1330, and the internal memories 1361 to 136n of the FUBs 1141 to 114n.

The lower-power management module 1310 may decide a wake-up of the power-off domain block 1100 according to data transferred from the wake-up FUB 1320. A power of the power-off domain block 1100 may be powered off during a standby state, for example, where the power-off domain block 1100 waits for an external input. The wake-up may mean such an operation that a power is again applied when external data is provided to the application processor 1000. That is, the wake-up may include an operation of allowing the application processor 1000 to go to an operating state (i.e., a power-on state) again.

The wake-up FUB 1320 may include a PHY 1330 and a LINK 1340. The wake-up FUB 1320 may interface between the low power management module 1310 and an external chip 3000. The PHY 1330 may actually exchange data with the external chip 3000, and the LINK 1340 may transmit and receive data actually exchanged through the PHY 1330 to and from the low power management module 1310 according to a predetermined protocol.

The keep alive FUB 1350 may determine a wake-up operation to be completed to undertaken by the wake-up FUB 1320, such as, for example, to activate or inactivate the power of the power-off domain block 1100. It is understood that the above is merely one illustrative example to which the disclosed subject matter is not limited.

The low power management module 1310 may receive data from at least one of the FUBs 1141 to 114n. In the event that data not processed and is only transferred, the low power management module 1310 may store the input data at an internal memory of a corresponding FUB instead of the core 1110.

Internal memories 1361 to 136n of the FUBs 1141 to 114n may be access by corresponding FUBs at a power-on mode and by the low power management module 1310 during a power-off or other low power mode.

The FUBs 1141 to 114n may further comprise a graphics processing unit (GPU), a modem, a sound controller, a security module, etc.

In example embodiments, a bandwidth selecting unit and/or a frequency selecting unit may include software which is executed by the core 1110. The bandwidth selecting unit and/or the frequency selecting unit may be includes in one of the FUBs 1141 to 114n. In another embodiment, The bandwidth selecting unit and/or the frequency selecting unit may be include a combination of software and hardware.

The external memory 2000 may correspond to a memory 120 or 220 described with reference to FIG. 1 or 7. The external chip 3000 may correspond to storage 130 or 230, a modem 140 or 240, or a user interface 150 or 250 described with reference to FIG. 1 or 7.

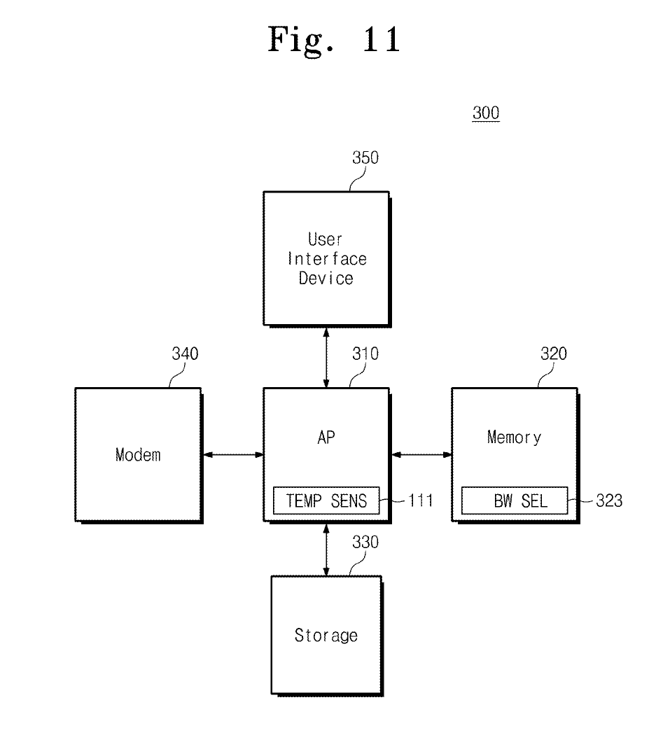

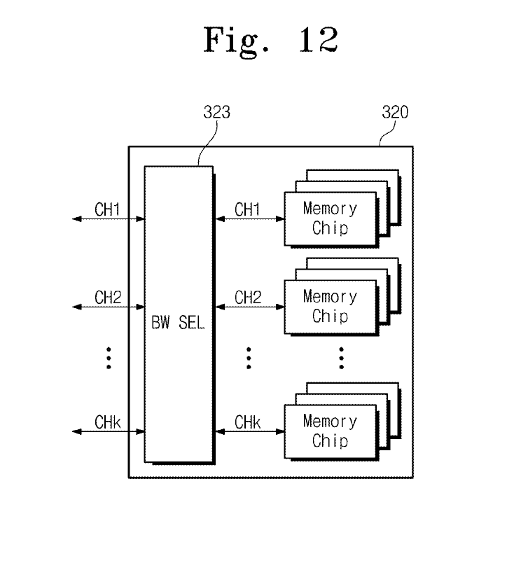

FIG. 11 is a block diagram schematically illustrating a mobile device 300 according to still another embodiment of the disclosed subject matter. Referring to FIG. 11, a mobile device 300 may include an application processor 310, a memory 320, storage 330, a modem 340, and a user interface device 350.

Compared with a mobile device 100 of FIG. 1, a bandwidth selecting unit 323 may be included in the memory 320. The bandwidth selecting unit 323 may control a bandwidth of the memory 320, based on information on a temperature input from the application processor 310. In example embodiments, as described with reference to FIG. 3 or 5, the bandwidth selecting unit 323 may control the number of channels or a data transmission rate of the memory 320. In various embodiments, a plurality of bandwidth selecting units (not shown) may exist in respective peripheral circuits (e.g., modem 340, etc.)

that control the bandwidth used to communicate between the AP 310 and the respective peripheral circuits.

FIG. 12 is a block diagram schematically illustrating a memory 320 of FIG. 11. Compared with a memory 120 of FIG. 4, a memory 320 of FIG. 12 may include a bandwidth selecting unit 323. Memory chips of the memory 320 may communicate with an application processor 310 through the bandwidth selecting unit 323. The bandwidth selecting unit 323 may control the number of channels, substantially simultaneously activated, from among channels CH1 to CHk or a data transmission rate of the channels CH1 to CHk.

In example embodiments, the bandwidth selecting unit 323 may adjust a bandwidth (e.g., a data transmission rate or the number of channels, etc.) by sending an interrupt to an application processor 310 according to a temperature detected. In various embodiments, the bandwidth selecting unit 323 may monitor the number of channels being employed for data communication. In such an embodiment, when the number of channels employed is equal to the reduced number of channels allowed at the higher temperature, the bandwidth selecting unit 323 may provide the application processor 310 with a signal indicating that all channels of the memory 320 are in use. In such an embodiment, the application processor 310 may not attempt to use more than the reduced number of channels.

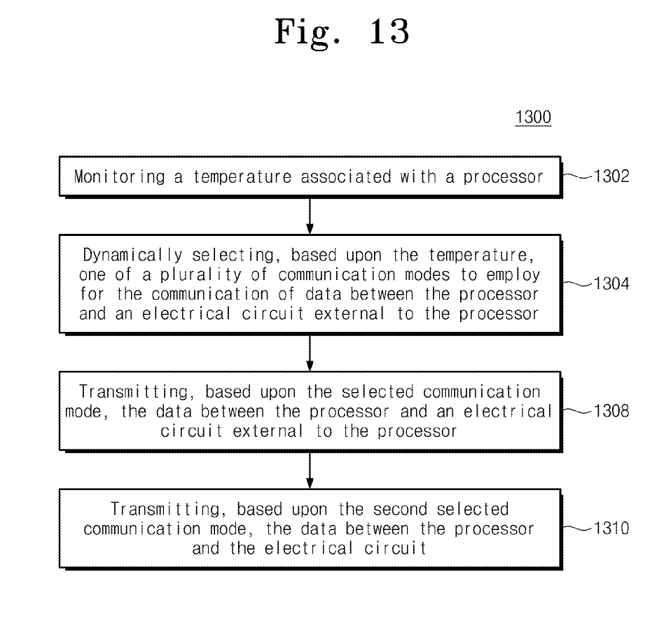

FIG. 13 is a flow chart illustrating a data communication mode selection technique 1300 according to another embodiment of the disclosed subject matter. In various embodiments, In various embodiments, the technique 1300 may be used or produced by the systems such as those of FIG. 1, 4, 6, 7, 10, or 11. Although, it is understood that the above are merely a few illustrative examples to which the disclosed subject matter is not limited. It is understood that the disclosed subject matter is not limited to the ordering of or number of actions illustrated by technique 1300.

Block 1302 illustrates that, in one embodiment, a temperature associated with a processor may be monitored. In various embodiments, this may include receiving a signal from a temperature sensor, as described above. In some embodiments, the temperature sensor may be embedded within the processor. In another embodiment, the temperature sensor may be external to the sensor. In various embodiments, the monitoring may occur or be performed by the processor. In another embodiment, the monitoring may occur or be performed by another device or component (e.g., a memory, and electrical circuit external to the processor, etc.).

Block 1304 illustrates that, in one embodiment, one of a plurality of communication modes may be selected based upon the monitored temperature, as described above. In various embodiments, the communication mode may control or affect the communication between the processor and an electrical circuit external to the processor (e.g., a memory, etc.). In various embodiments, the processor may be included within a portion of an integrated circuit or chip and the electrical circuit may be included within another portion of an integrated circuit or chip. It is understood that the above is merely one illustrative example to which the disclosed subject matter is not limited.

As described above, in various embodiments, the communication mode may include one or more of the following: a limit on the number of communication channels used for communication, a transmission data rate, a frequency of operation, a clock frequency of the processor and/or the electrical circuit, as described above. It is understood that the above are merely a few illustrative examples to which the disclosed subject matter is not limited. In various embodiments, the plurality of modes may include two modes, three modes, or a greater number of modes, as described above.

Block 1306 illustrates that, in one embodiment, the data may be transmitted between the processor and the electrical circuit, according to or based upon the selected communication mode. In such an embodiment, depending upon the selected communication mode, the data transmission may occur using only a limited number of channels, at a maximum data rate, with one (or more) of the circuits operating at a certain clock frequency, a subset thereof, or a combination thereof, as described above.

Block 1308 illustrates that, in one embodiment, a second communication may be selected when or if the monitored temperature changes. In such an embodiment, the communication mode may be dynamically altered to adapt to a changing environment (e.g., the rising or falling of the monitored temperature), as described above.

Block 1310 illustrates that, in one embodiment, the data may be transmitted between the processor and the electrical circuit, according to or based upon the second selected communication mode, as described above.

While the disclosed subject matter has been described with reference to exemplary embodiments, it will be apparent to those skilled in the art that various changes and modifications may be made without departing from the spirit and scope of the present disclosed subject matter. Therefore, it should be understood that the above embodiments are not limiting, but merely illustrative.

What is claimed is:

1. A method comprising:
detecting a temperature via a temperature sensor;
selecting a bandwidth for a communication of data by a semiconductor integrated circuit based, at least in part, upon the detected temperature; and
communicating the data based, at least in part, the selected bandwidth.

2. The method of claim 1, wherein the data is communicated between a peripheral circuit electrically connected with the semiconductor integrated circuit.

3. The method of claim 1, wherein the temperature sensor is embedded in the semiconductor integrated circuit.

4. The method of claim 1, wherein the temperature sensor is disposed outside of the semiconductor integrated circuit.

5. The method of claim 1, wherein the selecting a bandwidth comprises:
selecting a first number of channels for the communication of data when the detected temperature is lower than a threshold temperature; and
selecting a second number of channels for the communication of data when the detected temperature is higher than the threshold temperature, wherein the second number is less than the first number.

6. The method of claim 5, wherein the channels for the communication of data provide independent and parallel channels of communication between a peripheral circuit and the semiconductor integrated circuit.

7. The method of claim 5, wherein the semiconductor integrated circuit is connected with a peripheral circuit via a plurality of channels for the communication of data; and
wherein selecting a bandwidth comprises activating, substantially simultaneously, either the first number channels or the second number channels of the plurality of channels that are connected between the semiconductor integrated circuit and the peripheral circuit.

8. The method of claim 1, wherein the selecting a bandwidth comprises:
selecting a first data transmission rate when the detected temperature is lower than a threshold temperature; and
selecting a second data transmission rate when the detected temperature is higher than the threshold temperature, wherein the second data transmission rate is lower than the first data transmission rate.

9. The method of claim 1, wherein the semiconductor integrated circuit includes an application processor and the communication of data is performed between the application processor and a memory.

10. The method of claim 1, wherein the semiconductor integrated circuit includes a memory and the communication of data is performed between the memory and an application processor.

11. A mobile device comprising:
an application processor; and
a memory configured to communicate with the application processor based upon a bandwidth,
wherein the mobile device is configured to dynamically vary the bandwidth according to a temperature.

12. The mobile device of claim 11, wherein the application processor comprises a temperature sensor configured to detect the temperature; and
the application processor is configured to dynamically vary a number of channels employed for communication with the memory based, at least in part, upon the temperature detected by the temperature sensor.

13. The mobile device of claim 11, wherein the application processor comprises a temperature sensor configured to detect the temperature; and
the application processor is configured to change a data transmission rate of the communication with the memory according to the temperature detected by the temperature sensor.

14. The mobile device of claim 11, wherein the application processor comprises a temperature sensor configured to detect the temperature and
the memory is configured to, according to the temperature detected by the temperature sensor, dynamically vary either a number of channels employed for communication with the application processor or a data transmission rate of the communication with the application processor.

15. The mobile device of claim 11, wherein the application processor is further configured to adjust a frequency of an internal clock according to the temperature.

16. The mobile device of claim 11, wherein the application processor and the memory includes as part of a package-on-package.

17. The method of claim 1, wherein selecting a bandwidth for the communication of data by a semiconductor integrated circuit includes:
if the temperature is less than a first threshold temperature, selecting a first bandwidth for the communication of data,
if the temperature is greater than the first threshold temperature but less than a second threshold temperature, selecting a second bandwidth for the communication of data that is less than the first bandwidth, and
if the temperature is greater than the second threshold temperature, selecting a third bandwidth for the communication of data that is less than the second bandwidth.

18. The method of claim 1, wherein selecting a bandwidth for the communication of data by a semiconductor integrated circuit includes:
if the temperature is less than a first threshold temperature, selecting a first number of channels to be employed for the communication of data and selecting a first frequency of operation of the semiconductor integrated circuit,
if the temperature is greater than the first threshold temperature but less than a second threshold temperature, selecting a second number of channels to be employed for the communication of data and selecting the first frequency of operation of the semiconductor integrated circuit, wherein the second number is less than the first number, and
if the temperature is greater than the second threshold temperature, selecting the second number of channels to be employed for the communication of data and selecting a second frequency of operation of the semiconductor integrated circuit, wherein the second frequency is less than the first frequency.

19. The method of claim 1, wherein selecting a bandwidth for the communication of data by a semiconductor integrated circuit includes dynamically altering a frequency at which the semiconductor integrated circuit operates.

20. The method of claim 1, wherein detecting a temperature includes detecting a temperature associated with the semiconductor integrated circuit; and
wherein selecting a bandwidth includes selecting, by a peripheral circuit, the bandwidth for a communication of data between the semiconductor integrated circuit and the peripheral circuit.
